(19) United States
(12) Patent Application Publication
(10) Pub. No.: US 2013/0026301 A1
(43) Pub. Date: Jan. 31, 2013

(54) NACELLE FOR VARIABLE SECTION NOZZLE PROPULSION UNIT

(71) Applicants: Guillaume BULIN, Blagnac (FR); Patrick Oberle, Verdun Sur Garonne (FR); Nicolas Devienne, Toulouse (FR)

(72) Inventors: Guillaume BULIN, Blagnac (FR); Patrick Oberle, Verdun Sur Garonne (FR); Nicolas Devienne, Toulouse (FR)

(73) Assignee: AIRBUS OPERATIONS (SAS), Toulouse (FR)

(21) Appl. No.: 13/555,522

(22) Filed: Jul. 23, 2012

(30) Foreign Application Priority Data
Jul. 22, 2011 (FR) 1156690

(51) Int. Cl. F02K 1/06; B64D 29/00; F02K 3/02

(52) U.S. Cl. 244/53 R; 60/226.3; 239/265.19; 60/204

(57) ABSTRACT

The invention relates to a nacelle for a variable area nozzle propulsion unit comprising a nacelle, hosting a turbofan jet engine, of dual-flow type. The propulsion unit includes: a fixed part, carried by the inboard half-nacelle defined by a vertical plane of symmetry of the nacelle; and a movable part carried by the outboard half-nacelle. The moving part containing or releasing part of the secondary flow, depending on its open or closed position. The moving part being able to move to a discrete number of positions including a closed position, an open position, and one or more intermediate positions so as to provide variable area nozzle configurations for the turbofan engine.

This application claims priority to French Patent Application No. 1156690 filed Jul. 22, 2011, the entire contents of which are hereby incorporated by reference.

### BACKGROUND OF THE INVENTION

1. Field of the Invention

The present invention relates to the field of propulsion systems for aircraft. It relates more particularly to a propulsion unit with a variable ejector nozzle.

2. Discussion of Prior Art

The present invention relates to aircraft with dual-flow turbojet (or turbofan) engine having fans preferably at low compression ratio (typically less than 1.4). Such a propulsion unit of the dual-flow turbojet engine type, is illustrated in section view in FIG. 1, in an arrangement according to the prior art. One dual-flow jet engine includes a nacelle 1, mechanically suspended from the structure of an aircraft by a pylon 2 which extends inside the nacelle 1 for carrying a turbojet engine 3.

In very simple terms, the turbojet engine 3 sucks in outside air at an air intake 7 by means of a ducted propeller, i.e., fan 6, provided with an intake cone 13. The fan 6 is driven in rotation with the other compressor stages by a turbine (not shown). The air injected by the turbojet engine 3 is separated into two parts: on the one hand a primary flow circulating in a primary flow path 4, where the air is used for combustion of fuel in a combustion chamber, and whose combustion gases, highly accelerated, are ejected toward the rear of a turbojet engine 3 by an exhaust area 5.

On the other hand, the rest of the air flow (in fact, most) drawn and accelerated by the fan 6, is channeled by a secondary flow path 8 to a nozzle 9. The compression ratio of the fan 6 is defined as the ratio between the air pressure at the level of the nozzle 9 and the air pressure at the level of the air intake 7. The different elements forming a turbojet engine 3 are known to those skilled in the art, and are therefore not described further here.

Integrated with a nacelle 1, a variable area nozzle (also known as VAFN or “Variable Area Fan Nozzle”) is a discharge device for the secondary flow of the turbojet engine 3 through the nacelle 1, thus allowing an adjustment of the point operation of the fan 6 to provide improved engine performance. Such VAFN are known, for example U.S. Publication 2011/0120078A1 to Schwark published May 26, 2011 and herein incorporated by reference.

In effect, the thrust generated by the nozzle 9 depends on external conditions, the engine speed and the ratio of the input-output areas. It is then possible to optimize the engine speed and therefore the fuel consumption by adapting the output area of the nozzle. By varying the area of the nozzle 9 downstream from the fan 6, it is possible to obtain a more stable operation of the engine while optimizing fuel consumption and the level of engine noise.

This need for adaptation of the engine between the different speeds such as takeoff, landing and cruising, has resulted in the invention of different systems and designs. There are historically two main categories of variable area nozzles (also called air discharge devices) for dual-flow turbojet engine, which are made the subject of studies and patent applications:
A first category comprises devices that involve a translation an annular element of the nacelle such as a thrust reverser cowl, to uncover or cover an opening usually taking the form of a ring portion. Such a device is described for example in the patent “Thrust Modulating Apparatus” U.S. Pat. No. 3,797,785 A1 (Rohr Industries, Inc. 1973).
A second category for devices comprises at least one pivoting element (also called pivot door) between an open position and a closed position in a port formed in the nacelle of the turbojet engine.

In general, the devices of the first category have many disadvantages. The power required for their activation is therefore relatively high. Finally, it is difficult to provide a seal between the moving parts of these devices.

Known devices of the second category mentioned above also have a number of disadvantages. Thus, the patent FR 2.146.109 in 1973, describes an aircraft turbojet engine comprising an annular array of air discharge devices. Each comprises two pivoting cowls respectively sealing the inboard opening and the outboard opening with a port crossing the nacelle of the turbojet engine.

The two pivoting cowls of each device are articulated to the nacelle via one of their upstream and downstream edges, so as to open by pivoting in opposite directions: either totally to perform the function of thrust reverser or partially, to perform the function of air discharge device.

The dual function of the thrust reverser and air discharge device, as well as the independence of two pivoting cowls, requires the use of means of operation which are numerous and powerful, such as electric jacks. This makes both the cost and mass of these devices prohibitive. This also leaves little room for potential soundproofing materials that are necessary to reduce noise emitted by turbojet engines.

### SUMMARY OF THE INVENTION

The invention relates to a discrete, functionally asymmetric variable section nozzle device.

More precisely, the invention relates to a nacelle variable area nozzle unit, with the nozzle comprising a nacelle, housing a turbojet engine, of the dual-flow type including a fan, the secondary flow, drawn and accelerated by the fan, being channeled by a secondary flow path, formed in the nacelle between the inboard surface of the said nacelle and the outboard surface of the turbojet engine, across a nozzle, the nacelle is divided into two portions and includes: a fixed part half-nacelle defined by a vertical symmetry plane of the nacelle, and a movable half-nacelle, the movable portion containing or releasing part of the secondary flow, depending upon its position being opened or closed.

The movable portion of the nacelle being able to assume only a discrete number of positions, at least three positions, determining, in particular a closed position, a fully open position, and one or more intermediate positions said to be semi-open. The shape of the movable part being adapted to its output area, which is less than that of the fixed half-nacelle, when the movable part is closed, to that which its output cross section, is substantially equal to that of the half-nacelle, when the movable part is semi-open, and is greater than the half-nacelle when the movable part is fully open.

According to a first embodiment, the moving parts are extendable cowls arranged within the secondary flow path, at the rear part thereof, essentially in regard to the nozzle, the deployable cowls being translationally displaceable parallel to the longitudinal axis X of the turbojet engine, the nacelle having openings at the rear, so that these deployable cowls are adapted to uncover or cover these openings.

Advantageously, in this case, at least one deployable cowl is an element in the shape of an annular shaped nacelle. More specifically, each deployable cowl comes to merge with the inboard surface of the secondary flow path, in its closed position, and constitutes an extension of this surface back into its open position.

In another embodiment, the moving parts are pivotal elements, arranged at the outboard surface of the secondary flow path, at the rear part thereof, the nacelle comprising through openings formed in the nacelle of the turbojet engine, so that these pivoting elements are adapted, according to their open or closed position, to uncover or cover these openings.

The aim is to ensure the adaptation function of the thrust of the propulsion unit according to the altitude, in a powerful, simple, reliable, lightweight and energy efficient manner.

In the present invention, a variable area fan nozzle (VAFN) is used with asymmetry and independence in the discreet positioning of moving parts against each other. In a given design, the value of a discrete positioning system accepting the asymmetry lies in the fact that we obtain a larger number of positions by designing independent moving parts in their movement when they are synchronized to keep symmetry.

The invention also provides a method for optimizing engine speed of an aircraft propulsion unit comprising a nacelle so described, in which: in cruising flight, the moving part of each nacelle is closed; at take-off, the moving portion of each nacelle is in the open position; and in climbing or descending, the movable part, arranged furthest toward the outside of the aircraft is open, and every other moveable part is closed.

Advantageously, if a deployable cowl remains open in case of malfunction during the cruise, the pilot compensates for the asymmetry of thrust with the flight controls, and if an outboard deployable cowl remains closed during takeoff or landing, other deployable cowls are held in open position the pilot compensates for the asymmetry of thrust with the flight controls.

The invention also relates to a propulsion unit comprising a nacelle as outlined, and an aircraft having a nacelle as outlined.

### BRIEF DESCRIPTION OF THE DRAWINGS

The features and advantages of the invention will be better appreciated through the following description, a description that outlines the features of the invention through a non-limiting example of implementation:

FIG. 1 shows a dual-flow turbojet (turbofan) engine of conventional type, seen in longitudinal section;

FIG. 2 shows a functional diagram of asymmetric operation with two closed half-cowls (position 1);

FIG. 3 shows a functional diagram of asymmetric operation with two open half-cowls (position 2);

FIG. 4 shows a functional diagram of asymmetrical operation with an open and a closed half-cowl (position 3);

FIG. 5 shows a functional diagram in a first variant with a fixed half-cowl and a closed half-cowl;

FIG. 6 is a functional diagram in the first variant with a fixed half-cowl and a half-cowl in an intermediate position;

FIG. 7 shows a functional diagram in the first variant with a fixed half-cowl and an open half-cowl;

FIG. 8 shows a functional diagram of a second variant with two pivoting closed nacelle doors;

FIG. 9 shows a functional diagram of a second variant with an open pivoting door and a closed pivoting door;

FIG. 10 shows a functional diagram of a second variant with two pivoting open doors;

FIG. 11 shows a functional diagram of a third variant with four operating positions with half-cowls in motion; and

FIG. 12: a functional diagram of a third variant with four operating positions with pivoting doors.

### DETAILED DISCUSSION OF EMBODIMENTS

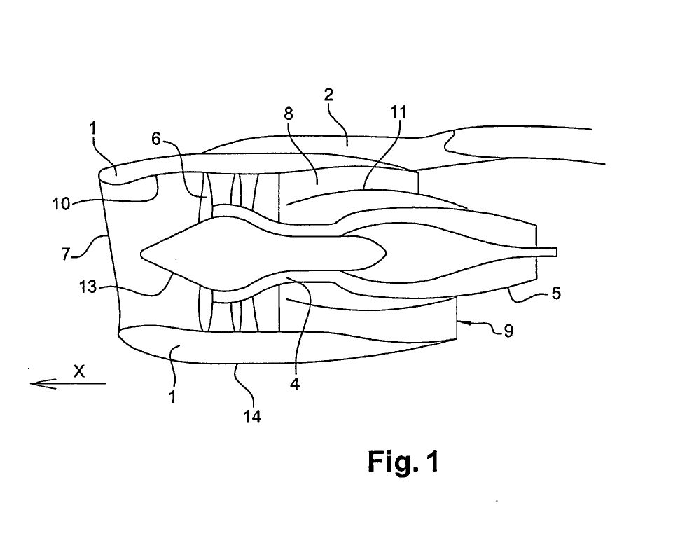

The invention fits inside a power path of the dual-flow turbojet engine as shown in sectional view in FIG. 1, already described above.

The device of the present invention comprises two independent parts called deployable half-cowls 20, 21 arranged on either side of a vertical plane of symmetry of the engine. Each of these deployable half-cowls 20, 21 is arranged within the secondary flowpath duct 8, at the rear part thereof, essentially with regard to the nozzle 9. Each deployable cowl comes to merge with the inboard surface 10 of the secondary duct 8, in a first position said to be closed, and constitutes an extension of this surface to the rear in a second position said to be open.

In an embodiment given here as a non-limiting example, for a turbofan engine with a thrust of 30,000 pounds and a by-pass ratio of 10:1, such a deployable half-cowl 20, 21 takes the form of a half ring of about 2 meters in diameter, about 40 cm in length with a relative thickness of 5 to 15%.

The device moreover comprises the means (not shown) to move independently of these deployable half-cowls 20, 21 moving in relation to the structure of the nozzle 5. For example a run of 15 to 30 centimeters will result in a variation of the output cross section of the secondary stream of 10 to 30%.

Each deployable half-cowl 20, 21 can occupy two positions, one said to be “closed” and the other said to be “open”. According to their position, opened or closed, the deployable half-cowls 20, 21 contain or release a portion of the secondary flow by varying the output section of the nozzle 9.

In the embodiment described here, there is no intermediate position possible, which contributes to the mechanical simplicity of the device as to surface variation of the nozzle. If one considers that the deployable half-cowls 20, 21 cover the same surface in terms of the secondary flow, then the corresponding output section of the nozzle 9 will take three values, in the following cases:

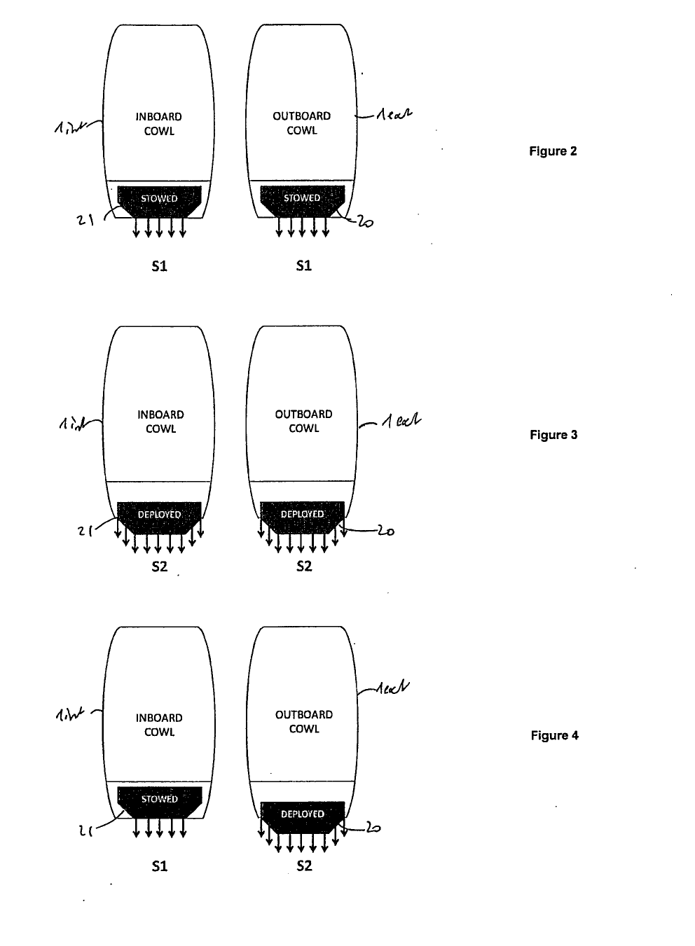

Position 1: The two deployable half-cowls are closed or stowed (FIG. 2);
Position 2: The two deployable half-cowls are open or deployed (FIG. 3); and
Position 3: One deployable half-cowl is closed, the other open (FIG. 4)

As seen above, the thrust generated by the nozzle 9 varies depending on external conditions, the engine speed and the ratio of the input-output areas. It is therefore possible to optimize the engine speed and the uptake by adapting the area of the output nozzle 9.

In the retracted or stowed position with the two deployable half-cowls 20, 21 closed, the nozzle 9 offers an output surface area of S1+S1 (FIG. 2). In the deployed position with the two deployable half-cowls 20, 21 open, the nozzle 9 has an output surface area S2+S2 (FIG. 3). Finally, in an intermediate position with a first deployable half-cowl 20 open and a second deployable half-cowl 21 closed, the nozzle 9 has an output surface area of S1+S2 (FIG. 4).

FIGS. 2-4 illustrate various configurations offered by the asymmetric operation of the discrete variable section nozzle 9 to a nacelle (represented by two half-nacelles, i.e., the inboard (1int) half-cowl and the outboard (1ext) half-cowl.

Mode of Operation

On a twin engine commercial aircraft, the proposed operation is as follows:

Case of Normal Operation

In cruising flight, the two deployable half-cowls 20, 21 are closed or stowed in each nacelle, which corresponds to optimal aerodynamic conditions at the cruising speed and altitude as shown in FIG. 2. At take-off, the two deployable half-cowls 20, 21 of each nacelle are in the open or deployed position and discharge part of the secondary flow at the rear of the nozzle 9 as shown in FIG. 3. While climbing or descending, the deployable half-cowl 20, closest to the outside of the aircraft is open (on the half-nacelle 1ext), and the other closed as shown in FIG. 4.

In Case of Failure

If a deployable half-cowl remains open in the event of failure during the cruise, the pilot or autopilot compensates for the asymmetric thrust with the flight controls. If an outboard deployable half-cowl remains closed during takeoff or landing, other deployable half-cowls, including those of the other engine (in the case of a twin engine aircraft) are held in closed position to restore the symmetry of thrust.

Advantages

A system of discrete asymmetrical operation offers the advantage of dispensing with a positioning servo system of the cowls and still provides three levels of thrust for each nacelle. This also permits simplifying the control of actuators and intrinsically accommodating a case of failure of one of the two deployable half-cowls (the other remaining available). The present invention thus improves reliability and safety compared to variable area nozzle servo-system in position or discrete but symmetrical systems.

Variations

By exploiting the concept of discrete positioning with asymmetric operation, several variants using the same criteria of functionality, simplicity and robustness are achievable. Depending on the design considered “by moving cowls” (described above), “by a fixed part and a moving part” or by “pivoting doors”, several solutions are obtained. These specific concepts are diagrammed schematically in FIGS. 5-12.

Variation 1: a fixed half-cowl in the inboard half-nacelle 1int, and a deployable half-cowl 20 which is movable to three positions and in the outboard half-nacelle 1ext and is illustrated by FIGS. 5-7.

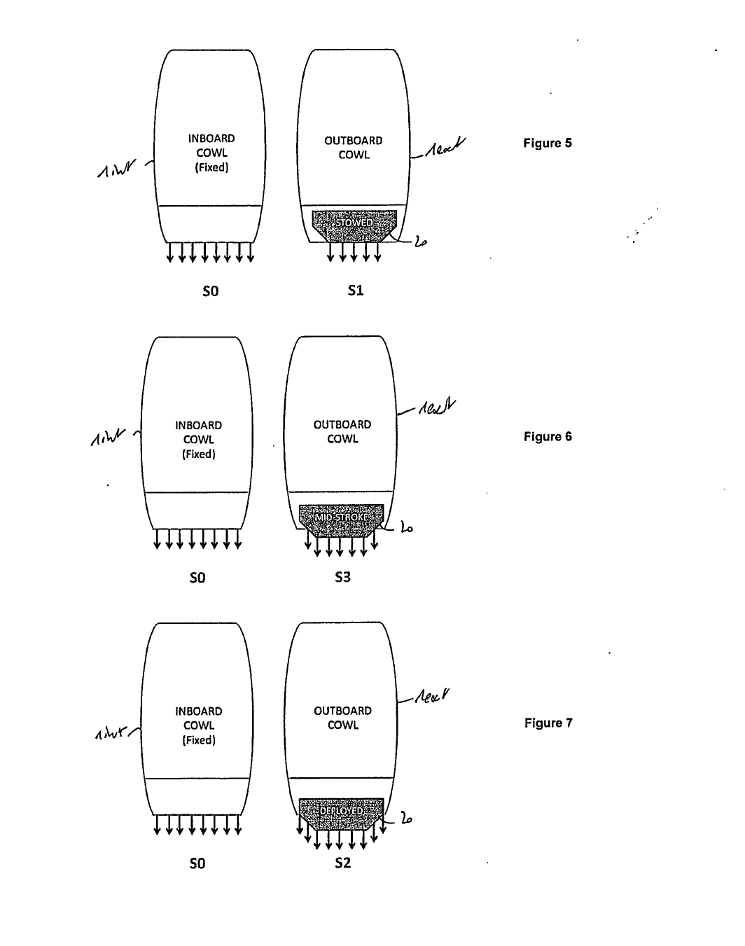

In this variation, the output cross section of the outboard half-nacelle 1ext, is less than that of the inboard half-nacelle 1int, when the deployable cowl 20 is closed (FIG. 5). The output cross sectional area of the external half-nacelle 1ext, is substantially equal to that of the area of the inboard half-nacelle, when the deployable half-cowl 20 is partially open (FIG. 6), and the area is higher when the deployable half-cowl 20 is fully open (FIG. 7).

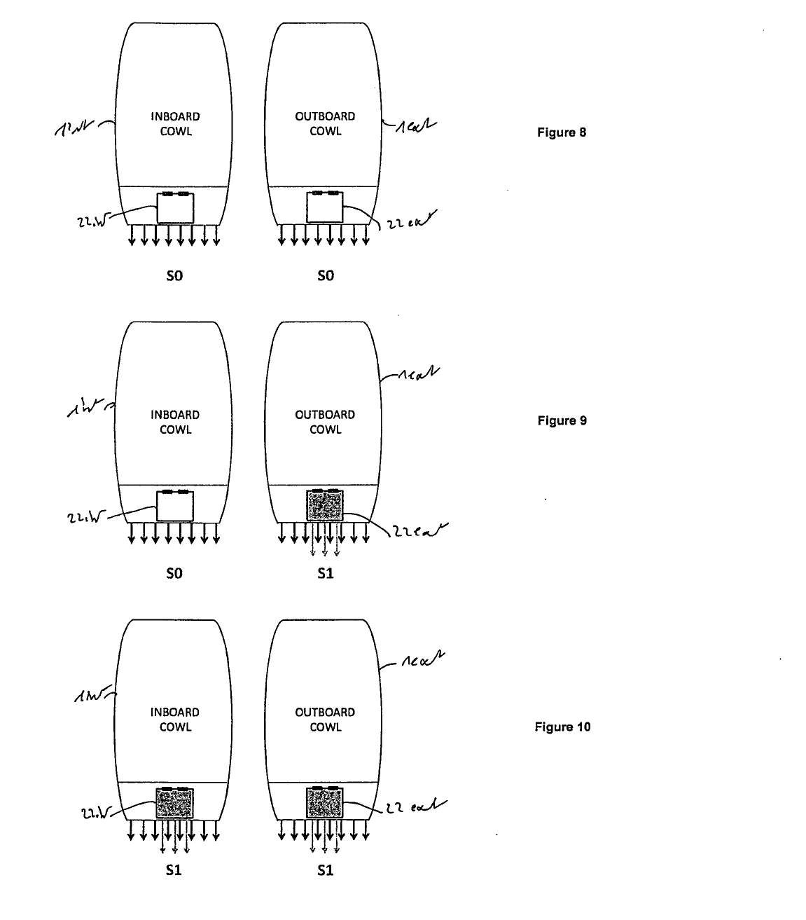

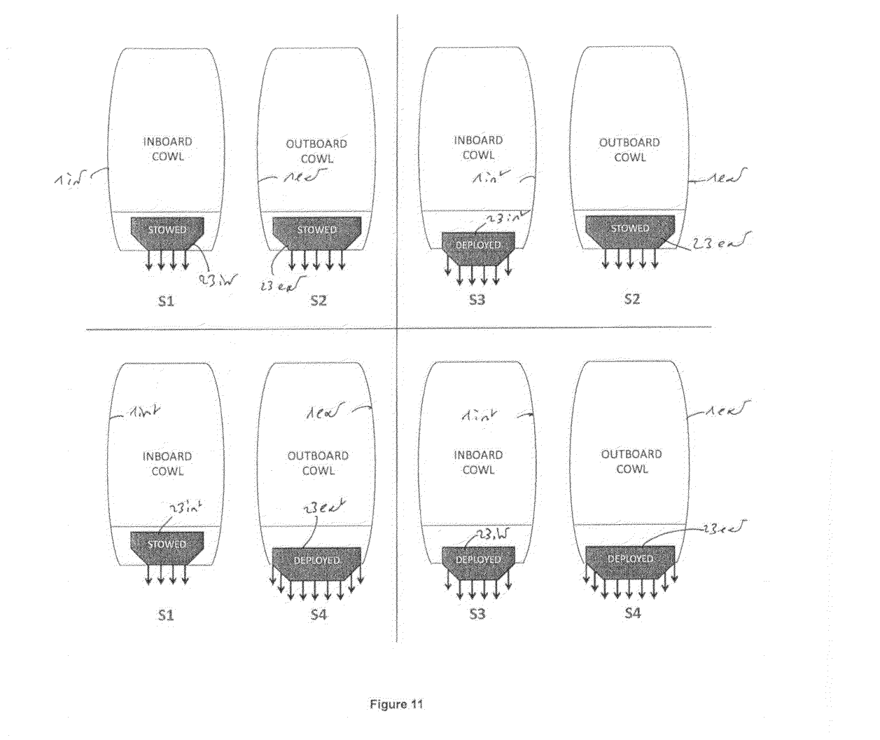

Variation 2: the two half-nacelles 1int, 1ext include the independent pivoting doors 22int, 22ext and this variation is illustrated by FIGS. 8-10. These pivoting doors 22int, 22ext are of the type described in the preamble of this application. Here again, the output cross section generated from the nacelle varies among three values, depending on whether the pivoting doors are both closed (FIG. 8), inboard pivoting door open and outboard pivoting door closed (FIG. 9), or both pivoting doors open (FIG. 10). The output cross section is maximized when the two pivoting doors are open.

Variation 3: cowl or door operation at four positions. Sub-variation 1: each nacelle carries two translationally displaceable deployable cowls of different nozzle areas. In this non-limiting example, the deployable inboard cowl 23int of the inboard half-nacelle is of smaller size than the deployable outboard cowl 23ext of the outboard half-nacelle 1ext. This variation is illustrated in FIG. 11.

Operation in Flight

In this variation, the two deployable cowls 23int, 23ext of each nacelle do not have the same area on each half-nacelle 1int, 1ext, thus offering four different combinations respectively. This operation has the same simplicity in terms of steering and control as the solution of three positions and allows for optimization of the engine speed in a case of sustained flight at a less than optimum cruise altitude (e.g. flight stabilized on hold at low altitude). Speed 1 with nozzle output area=S1+S2 (FIG. 11 top left); Speed 2 with nozzle output area=S2+S3 (FIG. 11 top right); Speed 3 with nozzle output area=S1+S4 (FIG. 11 bottom left); and Speed 4 with nozzle output area=S3+S4 (FIG. 11 bottom right).

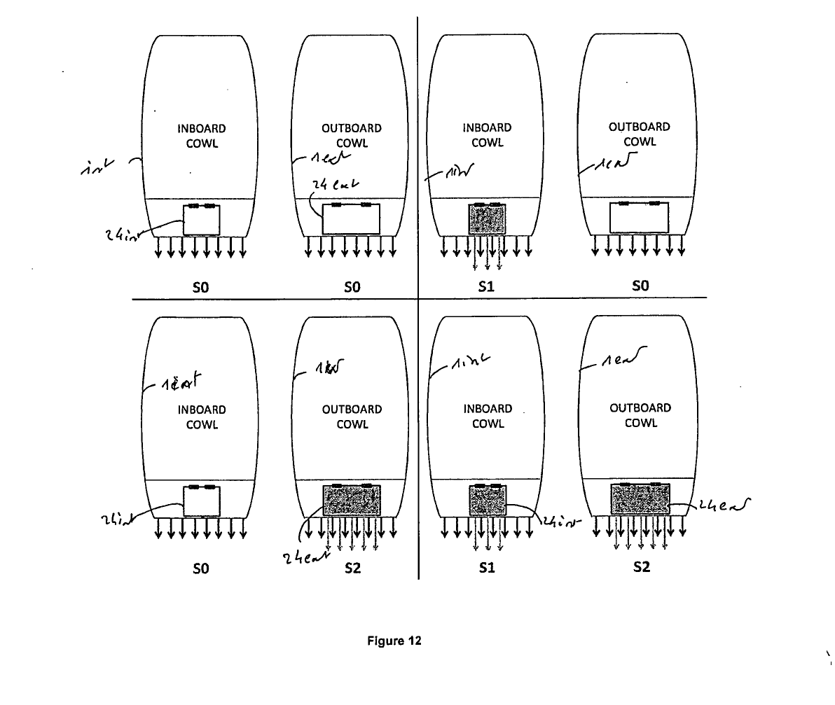

Sub-variation 2: 1 each nacelle carries two pivoting doors of different sizes. In this non-limiting example, the inboard pivoting door of the inboard half-nacelle 24int nacelle 1int is smaller than the pivoting door of the outboard half-nacelle 24ext 1ext. This variation is illustrated by FIG. 12.

Operation in Flight

As previously, we can optimize four engine speeds: Speed 1 with nozzle output area=S0+S0 (FIG. 12 top left); Speed 2 with nozzle output area=S0+S1 (FIG. 12 top right); Speed 3 with nozzle output area=S0+S2 (FIG. 12 bottom left); and Speed 4 with nozzle output area=S1+S2 (FIG. 12 bottom right).

Variation 4: one fixed and one moveable continuous portion (variation not illustrated). Another variation is that one half-nacelle includes a fixed half-cowl, and that the other half-nacelle includes a translationally displaceable deployable half-cowl thus continuously controllable, and not only to a specific number of discrete positions. This solution would be a compromise between the discrete and continuous positioning but still operating asymmetrically. This has certain advantages of simplicity of design and control in continuous servo.

In another embodiment, each cowl carries two pivoting doors of different sizes, the pivoting door of the inboard half-nacelle is larger than the outboard pivoting door of the half-nacelle. The operating principle is identical to the above.

1. A nacelle for a variable area nozzle propulsion unit for a turbofan jet engine, wherein the nacelle hosts a turbofan engine having a fan, the turbofan engine having primary and secondary flows, the primary flow is to the turbojet compressor, combustor and turbine portions and the secondary flow is drawn and accelerated by the fan through a secondary flow path provided in the nacelle between the inboard surface of the said nacelle and the outboard surface of the engine to a nozzle, said nacelle having a variable nozzle area, wherein the nacelle comprises:
one fixed part carried by a portion of the nacelle defining a fixed nozzle area, and
a movable part carried by another portion of the nacelle defining a variable nozzle area, said movable part containing or releasing a portion of the secondary flow in dependence on an open, intermediate or closed position, the shape of the movable part having a nozzle area: less than the nozzle area of said fixed part in said closed position; substantially equal to the nozzle area of said fixed part in said intermediate position; and greater than the nozzle area of said fixed part in said open position.

2. The nacelle according to claim 1, wherein the moving parts are deployable cowls arranged within the secondary flow path, at the rear part thereof, essentially in reference to the nozzle, said deployable cowls being translationally displaceable parallel to the longitudinal axis X of the turbojet engine, the nacelle having openings at the rear, so that these deployable cowls are adapted to uncover or cover these openings.

3. The nacelle according to claim 1, wherein at least one deployable cowl is a unit in the form of a annular segment nacelle.

4. The nacelle according to claim 1, wherein each deployable cowl comes to be merged with the inboard surface of the secondary flow path, in its closed position, and constitutes an extension of this surface to the back in its open position.

5. The nacelle according to claim 1, wherein the moving parts are pivotal units, arranged at the outboard surface of the secondary flow path, at the rear part thereof, the nacelle comprising passage openings formed in the nacelle of the turbojet engine, so that these pivoting units are adapted, according to their open or closed position, to uncover or cover these openings.

6. A method of optimizing engine speed of an aircraft propulsion unit comprising a nacelle according to claim 1, wherein:
in cruising flight, the movable part of each nacelle is closed,
at take-off, the moveable part of each nacelle is in the open position,
in climbing or descending, the movable part arranged furthest toward the outside of the aircraft is open, and every other moveable part is closed.

7. A method according to claim 8, wherein:
if a deployable cowl remains open in case of failure during the cruise, means for controlling the aircraft compensate the asymmetry of thrust with the flight controls,
if an outboard deployable cowl remains closed during takeoff or landing, other deployable cowls are held in open position and means for controlling the aircraft compensate the asymmetry of thrust with the flight controls.

8. Propulsion unit characterized in that it comprises a nacelle according to claim 1.

9. Aircraft, characterized in that it comprises a nacelle according to claim 1.
